(19) United States
(12) Patent Application Publication
(10) Pub. No.: US 2010/0106959 A1
(43) Pub. Date: Apr. 29, 2010

(54) Triple and quadruple churning security for 1G and 10G PON

(75) Inventors: Onn Haran, San Jose, CA (US); Lior Khermosh, Givatayim (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: PMC Sierra Ltd., Herzlia Pituach (IL)

(21) Appl. No.: 12/624,460

(22) Filed: Nov. 24, 2009

Related U.S. Application Data
(63) Continuation-in-part of application No. 11/380,942, filed on May 1, 2006, now Pat. No. 7,646,870.
(60) Provisional application No. 60/750,824, filed on Dec. 16, 2005.
(60) Provisional application No. 61/142,387, filed on Jan. 5, 2009.

(51) Int. Cl. H04L 9/00

(52) U.S. Cl. 713/150

(57) ABSTRACT

A data encryption-decryption method for enhancing the confidentiality of data transmitted between two, first and second communication network entities including the steps of: at the first network entity, performing a quadruple-churning operation on a byte N to obtain an encrypted byte N, the quadruple-churning operation including: performing a first churning operation to obtain a first churned output; bit-wise XORing the first churned output with two values to obtain a first XOR result; bit-swapping the first XOR result; performing a second churning and XORing stages to obtain a second XOR result; performing a third churning and XORing stages to obtain a third XOR result; bit swapping the third XOR result; and performing a fourth churning operation on the third bit-swapped XOR result to obtain encrypted byte N; and transmitting the encrypted byte N to the second network entity.

### CROSS-REFERENCE TO RELATED APPLICATIONS

The present invention claims priority from U.S. patent application Ser. No. 11/380,942, filed May 1, 2006, and from U.S. Provisional Patent Application No. 61/142,387 filed Jan. 5, 2009, the content of which is incorporated herein by reference.

### FIELD OF THE INVENTION

The present invention relates to data encryption-decryption methods, more particularly to improved churning methods, and most particularly to improved churning in passive optical networks (PON).

### BACKGROUND OF THE INVENTION

Data encryption-decryption is necessary in a variety of communication technologies. Communication between any two entities is made more secure by encrypting the data. Specifically, communications through PONs may benefit from improved data encryption.

PONs having a plurality of optical network units (ONU) communicating with an optical line terminal (OLT) are well known in the art. An exemplary PON is shown schematically in FIG. 1. Specifically, the figure shows at Ethernet PON (EPON) 100 that has an OLT 102 communicating with three ONUs 106, 108 and 110 through a splitter 104. One of the key international standard specifications for a PON-based broadband optical access system is given by ITU-T Recommendation G.983.1. G.983.1 includes description of a data encryption function termed “churning” to offer a protection capability for data confidentiality purposes. This function is mandatory because, in a PON system, the OLT always physically broadcasts information downstream, but only one ONU at a time can decode the information. More specifically, in the system of FIG. 1, OLT 102 first sends a certain downstream message to request each ONU (e.g., ONU 106) to provide its churning key. In response to this request, the ONU 106 generates a churning key and sends it back to the OLT 102. With the received churning key, the OLT 102 encrypts, or churns, downstream cells before sending them out to ONU 106. This data churning operation for downstream cells is performed on an individual virtual path (VP) basis. OLT 102 notifies ONU 106 of which virtual path is churned or not, by sending a special downstream message indicating the virtual path identifier (VPI) of a particular path that is churned or not churned. This information is referred to as “churning parameters”.

All ONUs in a PON system have their respective churning keys, and the churning of downstream information can be enabled or disabled separately for each VPI. The OLT sends downstream messages to notify each ONU of churning parameters before sending downstream cells. When data is received through a churned VP, the destination ONU decodes the data with its own churning key. Churning is a memory-less and history-less function. Every byte is churned without relation to any other byte. The transformations of some nibbles may be identified by using a very simple method based on the knowledge of known fields in packets.

Churning was suggested as a compromise for a non-encryption solution. As shown below, a major current disadvantage is that the decoding of churning is trivial. Churning is easily broken using a very few packets and a breaking tool.

Since churning is different for upper and lower nibbles, two different tables are maintained by the breaking tool, but isolating data patterns is simpler because it is easier to identify patterns when looking at nibbles. Following that, a simple differential cryptographic method is used by the breaking tool. Churning is a simple shift of a single bit in a nibble to a different bit location in a nibble with potential inversion. By locating the transformation of each bit, the entire transformation table is known.

The entire process is carried out by the breaking tool without caring about the key. The key itself is not important. The only important information is the nibble transformation. Each output bit is affected only by a single input bit of the same nibble.

Consequently, it would be advantageous to have a churning method that will provide better encryption security than known churning methods for 1G and 10G PONS.

### SUMMARY

It is known to enhance the confidentiality of data transmitted between two, first and second communication network entities by steps including receiving a data byte N and performing a triple-churning operation on byte N to obtain an encrypted byte N.

According to the teachings of the present embodiment there is provided a method for enhancing the confidentiality of data transmitted between two, first and second communication network entities including the steps of: at the first network entity, performing a quadruple-churning operation on a byte N to obtain an encrypted byte N, the quadruple-churning operation including: performing a first churning operation to obtain a first churned output; bit-wise XORing the first churned output with two values to obtain a first XOR result; bit-swapping the first XOR result; performing a second churning operation on the first bit-swapped XOR result to obtain a second churned output; bit-wise XORing the second churned output with two values to obtain a second XOR result; performing a third churning operation on the second XOR result to obtain a third churned output; bit-wise XORing the third churned output with two values to obtain a third XOR result; bit swapping the third XOR result; and performing a fourth churning operation on the third bit-swapped XOR result to obtain encrypted byte N; and transmitting the encrypted byte N to the second network entity.

In an optional embodiment, each bit-wise XORing with two values includes bit-wise XORing with a data input and a previous data output. In another optional embodiment, at least one of the two values in each bit-wise XORing with two values is 0. In another optional embodiment, the bit-wise XORing of the first churned output with a data input and a data output includes XORing with an input of a previous byte N-1 and an output of a previous byte N-4. In another optional embodiment, the bit-wise XORing of the second churned output with a data input and a data output includes XORing with an input of a previous byte N-2 and an output of a previous byte N-5. In another optional embodiment, the bit-wise XORing of the third churned output with a data input and a data output includes XORing with an input of a previous byte N-3 and an output of a previous byte N-6.

In another optional embodiment, the performing a first churning operation to obtain a first churned output includes using an original 32-bit key, wherein the performing a second churning operation on the first XOR result to obtain a second churned output includes using the original 32-bit key shifted by one byte, placing the least significant byte first, followed by the two most significant bytes, wherein the performing a third churning operation on the second XOR result includes using the original 32-bit key shifted by two bytes, placing the two least significant bytes first followed by the most significant byte, and wherein the performing a fourth churning operation on the third XOR result includes using the original 32-bit key shifted by three bytes, placing the three least significant bytes first.

Another optional embodiment further includes, at the second network entity, performing a quadruple de-churning operation on encrypted byte N to obtain back original byte N. In another optional embodiment, the communication network is a passive optical network, wherein the first network entity is an optical line terminal, and wherein the second network entity is an optical network unit. In another optional embodiment, the communication network is a passive optical network, wherein the first network entity is an optical network unit, and wherein the second network entity is an optical line terminal.

### BRIEF DESCRIPTION OF FIGURES

For a better understanding of the present invention, and to show more clearly how it could be applied, reference will now be made by way of example only, to the accompanying drawings in which:

FIG. 1 shows an exemplary passive optical network;

FIG. 2 shows a triple-churning scheme according to the present invention;

FIG. 3 shows schematically a data influence diagram;

FIG. 4 shows a reverse triple-churning scheme according to the present invention;

FIG. 5 shows a packet format for triple-churning;

FIG. 6 shows a key exchange notification scheme as applied to triple-churning key exchange;

FIG. 7 shows an implementation of a quadruple-churning scheme;

FIG. 8 shows an implementation of a reverse quadruple-churning scheme.

### DETAILED DESCRIPTION

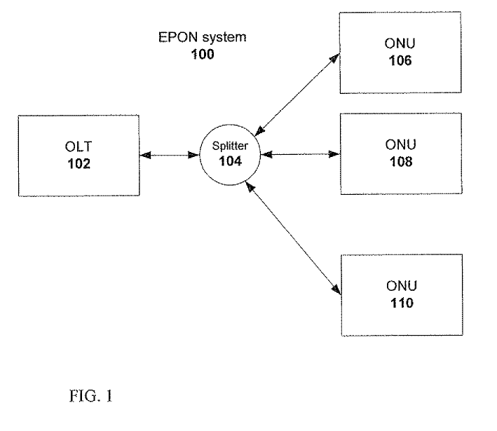

### First Embodiment—FIGS. 1, 2, 3, 4, 5, 6

Disclosed herein are improved churning methods, referred to herein as “triple-churning” and “quadruple churning”. The methods can be used for improving data security in communications between any two elements that exchange data. While described in detail with reference to PONs, it should be understood that the triple and quadruple churning methods disclosed herein are equally applicable to other communication networks.

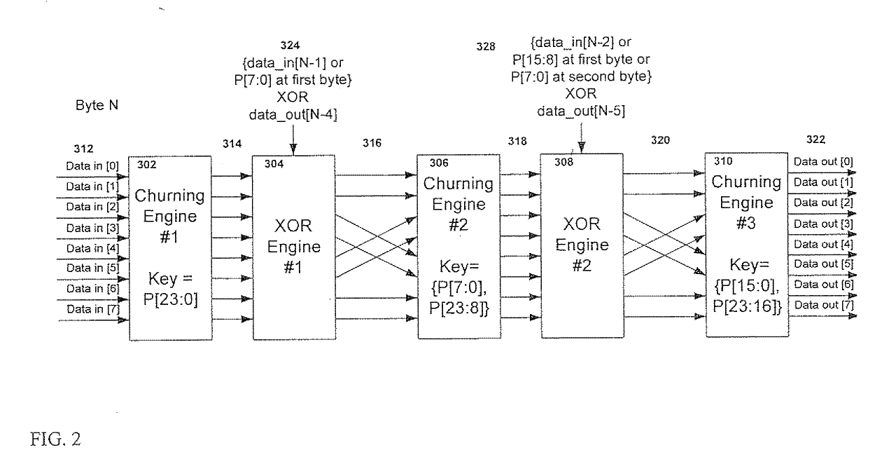

FIG. 2 shows a preferred embodiment triple-churning scheme based on cascading three churning engines. A first churning engine 302 uses the original 24-bit key P [23:0] used by all churning engines. A second churning engine 306 uses the same key shifted by one byte {P [7:0], P [23:8]}, placing the least significant byte first, followed by the two most significant bytes. A third churning engine 310 uses the same key shifted by two bytes {P [15:0], P [23:16]}, placing the two least significant byte first, followed by the most significant byte.

In use, byte N of data 312 is input into and churned in the first churning engine into an output 314. Output 314 is bit-wise XORed with two inputs (values) in a first XOR engine 304. The two inputs are an input 312 of the previous byte {data_in [N-1] or P[7:0] of first byte} and a previous data output 324 of 4 bytes ago, data_out [N-4]. The first value is used to add the influence of this byte into a final data output 322. In the value is the first byte of the packet, the least significant byte of the key is used. The second input to the XOR element (324) is used to whiten the input data (making sure the data looks random if the input data is totally static) and to make sure that repeated patterns will not be detected. This is somewhat similar to Cipher Block Chaining (CBC) mode, however, CBC uses just the input data (312), while here the output data (324) is also used. In the case of the first 4 bytes of the packets, the value 0 is used instead.

A result 316 of the first XOR operation is passed to second churning engine 306 after a bit shift in a transition (bit swap), and churned into an output 318. Bits 0, 1, 6, and 7 pass “as is”. Bits 2 and 5 are swapped, and so are bits 3 and 4.

Output 318 is also bit-wise XORed with two inputs in a second XOR engine 308. The first value is a previous data input byte [N-2] 328. In the case of the first byte of the packet, the second byte of the key P [15:8] is used instead of data_in [N-2]. In the case of the second byte of the packet, the least significant byte of the key P [7:0] is used instead of data_in [N-2]. The second input to XOR engine 308 is a previous data output data [N-5] of 5 bytes ago. A result 320 of the second XOR operation is passed to third churning engine 310 after a bit swap as in the case of the first XOR operation. The output of the third churning engine is an “encrypted byte N”. Overall, each output byte is influenced by 24 input bits.

In alternative embodiments, one or both inputs to either XOR engine may be 0, in which case the respective XOR function is inactive. Each XOR engine is therefore an “optional” element of the triple-churning system.

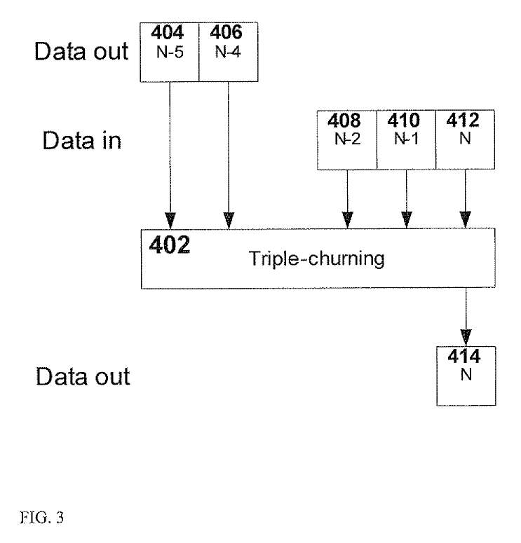

FIG. 3 shows a data influence diagram that depicts, for a single output byte 414 which is the result of a single activation of the triple-churning engine, the last 3 input bytes 408, 410, 412 and previous output bytes 404, 406 that participate in the calculation of the current output byte. Output 414 corresponds to output 322, input 412 corresponds to input 312, 408 and 404 are used in 324 and 410 and 406 are used in 328 in FIG. 2

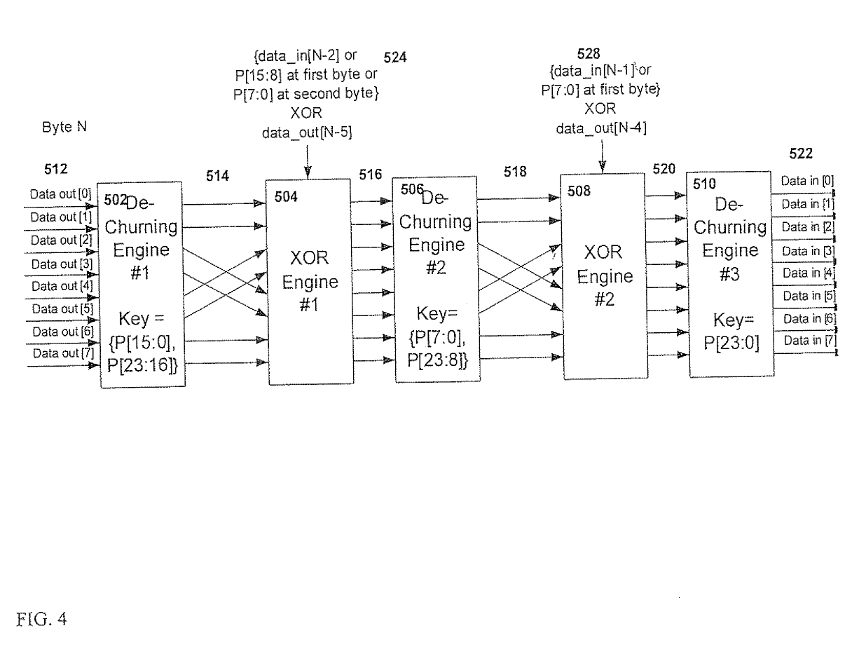

The churning function is reversible. The reverse function is a simple mirror of the triple-churning. Opening the triple-churning requires reversing the order of operations. The reversal is illustrated in FIG. 4. Each churning engine is replaced with a de-churning engine. All the operations before the engines are simply performed in the reverse order they were previously performed.

The format of a packet entering the system of FIG. 2 is shown in FIG. 5. Each original packet includes an original packet preamble 602, and an original packet content from DA to CRC 604. Each encrypted packet includes a packet preamble 612 that is modified for adding encryption control and an encrypted packet content 614. The entire packet from DA until CRC is encrypted. The complete packet encryption provides the receiving side an indication that the packet was decrypted correctly. The preamble passes in the clear, in other words information from the preamble can be used in the decryption process.

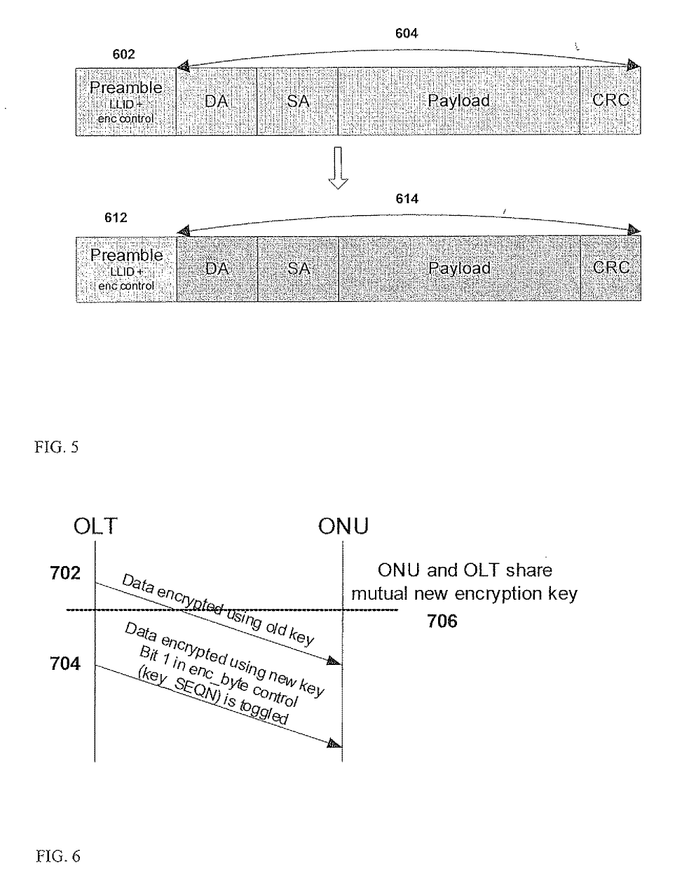

FIG. 6 shows a non-limiting example of a key exchange notification scheme. Other schemes may be equally useful. The fifth byte of the preamble, the one before the LLID, is used for key exchange and encryption control, as illustrated in 612. The least significant bit is set to 1 when the packet is encrypted and to 0 otherwise. The next two least significant bit marks the currently used key. This is required to perform key exchange. When the OLT decides to use a new key, it must toggle the current key number in the preamble, and use the new key. In FIG. 6, 702 indicates a packet encrypted by the current key. The key must be known to both the OLT and a respective ONU before the exchange, as occurs in step 706. The new key can be originated by either the ONU or the OLT, and passed through vendor specific OAM packet. Following that stage, the new key is used in step 704

While triple churning has been described with respect to a limited number of embodiments, it will be appreciated that many variations, modifications and other applications of triple churning as described above may be made. Variations may include, for example, variations of a bit for the churning key, different byte indexes for the XOR values and different bit transformation. To cite a few non-limiting examples:

1. Different indexes used in the XOR blocks in FIG. 2. For example, data in[N-2] instead of data_in[N-1] can be used as element 324.

2. Different permutations for the keys. There are 32!=2E35 different options, and exemplarily one of these can be P[3:0], P[31:28].

3. Different key values can be XORed, for example, P[9:2] instead of P[7:0].

4. Different bit swap options after the XOR blocks. There are 8!=40320 different options, such as bit[7:0]={bit[0], bit[7:1]}

### DETAILED DESCRIPTION

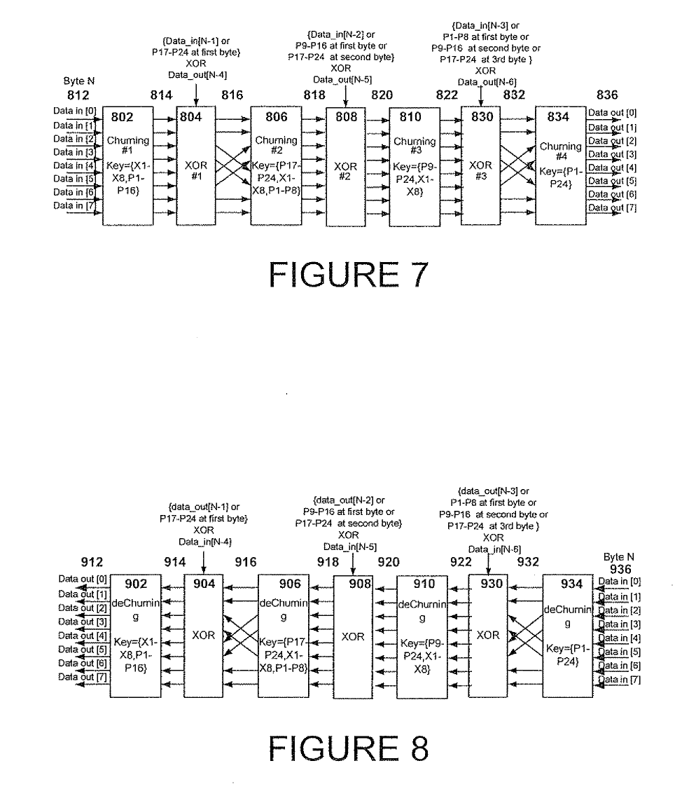

### Second Embodiment—FIGS. 7, 8,

The above-described system for triple churning is highly effective for 1G PON. However, there is a need to provide a new scheme for enhancing the confidentiality of data transmitted between network entities for 10G PON.

The triple-churning described above includes a key of 24 bits. Key exchange is mostly done in OAM messages and requires sufficient time for message transmission and key exchange. For a key length of 24 bits, the rate recommended for key exchange is once every 10 seconds. Each PON has 32 to 64 ONUs and an OLT line card can contain 4 to 8 PONs. This network configuration requires hundreds of OAM messages to be handled by the OLT, in addition to the time needed for the ONUs to respond. The need for a relatively fast key exchange rate is not facilitated easily by the OAM protocol that is relatively slow, about 10 messages per second. In addition, this relatively fast key exchange rate is a burden to host management on the OLT and can result in slow software response.

The data rate for 100 PON is ten times faster than the date rate for 1G PON. This faster data rate is designated as X10, meaning in the same time period, ten times (X10) the number of bits are transferred in 10G PON as compared to 1G PON. Because data is transferred X10 in 10G PON, to implement the same level of security in 10G PON as in 1G PON, a new key needs to be exchanged ten times faster, which is once per second. Depending on the application, the key exchange may need to be more frequent than once per second. Given the above-described network configuration for PON, and the key exchange requirements for 10G PON, a new scheme is needed to enhance the confidentiality of data transmitted between network entities for 10G PON.

The following description discloses an implementation for enhance the confidentiality of data transmitted between network entities for 10G PON, referred to herein as “quadruple-churning”. Quadruple-churning is an improved security scheme compared to the triple-churning security scheme previously described. Because quadruple-churning is an improved scheme compared to triple-churning, the key exchange rate for quadruple-churning can be relatively slower than the key exchange rate for triple-churning, facilitating implementation for 10G PONs.

Referring to FIG. 7, an implementation of a quadruple-churning scheme, four churning engines and a 32-bit key are used. The 32 bit key is notated as bits {[X1-X8], [P1-P24]} and the appropriate 24 bits from this 32 bit key are used in each churning engine.

A first churning engine 802 uses 24 bits {[X1:X8], [P1-P16]} from the original 32-bit key used by all churning engines. A second churning engine 806 uses 24 bits of the same key shifted by one byte {[P17:P24], [X1:X8], [P1-P8]}, placing the least significant byte first, followed by the two most significant bytes. A third churning engine 810 uses 24 bits of the same key shifted by two bytes {[P9:P24], [X1:X8]}, placing the two least significant byte first, followed by the most significant byte. A fourth churning engine 834 uses 24 bits of the same key shifted by three bytes {[P1:P24]}, placing the three least significant byte first. In FIG. 7, the last four stages of the input are taken and the last seven stages are taken and churned with a 32-bit key, using the basic churning engine as described above. This basic churning engine uses single churn elements of data byte and a key of 24 bits. The data bits are shifted during the churning. This engine provides a white churning of the data with a security key length of 32 bits.

This data encryption-decryption scheme includes the steps of receiving a data byte N and performing a quadruple-churning operation on byte N 812 byte N-1, Byte N-2, byte N-3 and output of byte N-4, N-5 and N-6 to obtain an encrypted byte N 836. Preferably, the quadruple-churning operation includes performing a first churning operation 802 to obtain a first churned output 814, performing a first bit-wise XORing 804 on the first churned output 814 with two values to obtain a first XOR result 816, performing a second churning operation 806 on the first XOR result 816 to obtain a second churned output 818, performing a second bit-wise XORing 808 on the second churned output 818 with two values to obtain a second XOR result 820, performing a third churning operation 810 on the second XOR result 820 to obtain a third churned output 822, performing a third bit-wise XORing 830 on the third churned output 822 with two values to obtain a third XOR result 832, and performing a fourth churning operation 834 on the third XOR result 832 to obtain encrypted byte N 836.

Referring to FIG. 8, an implementation of a reverse quadruple-churning scheme, also known as “quadruple-dechurning”, the reverse function is a simple mirror of the quadruple-churning. Opening the quadruple -churning requires reversing the order of operations, as illustrated in FIG. 8. Each churning engine is replaced with a de-churning engine. All the operations before the engines are simply performed in the reverse order they were previously performed.

Similar to the description of triple-churning, quadruple-churning has been described with respect to a limited number of embodiments, it will be appreciated that many variations, modifications and other applications of the invention may be made. Based on the above description, it will be apparent to one skilled in the art that the triple-churning and quadruple-churning systems can be extended by adding churning and XORing stages to create an N-churning system. Similarly, the length of the encryption key can be extended. This method and system facilitates implementation of de-churning by extending the de-churning stages in a similar manner. These extensions provide increased security and alternate implementations for a variety of applications.

All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

It will be appreciated that the above descriptions are intended only to serve as examples, and that many other embodiments are possible within the scope of the present invention as defined in the appended claims.

What is claimed is:

1. A method for enhancing the confidentiality of data transmitted between two, first and second communication network entities, comprising the steps of:
(a) at the first network entity, performing a quadruple-churning operation on a byte N to obtain an encrypted byte N, the quadruple-churning operation including:
(i) performing a first churning operation to obtain a first churned output;
(ii) bit-wise XORing the first churned output with two values to obtain a first XOR result;
(iii) bit-swapping the first XOR result;
(iv) performing a second churning operation on the first bit-swapped XOR result to obtain a second churned output;
(v) bit-wise XORing the second churned output with two values to obtain a second XOR result;
(vi) performing a third churning operation on the second XOR result to obtain a third churned output;
(vii) bit-wise XORing the third churned output with two values to obtain a third XOR result;
(viii) bit swapping the third XOR result; and
(ix) performing a fourth churning operation on the third bit-swapped XOR result to obtain encrypted byte N; and
(b) transmitting the encrypted byte N to the second network entity.

2. The method of claim 1, wherein each bit-wise XORing with two values includes bit-wise XORing with a data input and a previous data output.

3. The method of claim 1, wherein at least one of the two values in each bit-wise XORing with two values is 0.

4. The method of claim 1, wherein the bit-wise XORing of the first churned output with a data input and a data output includes XORing with an input of a previous byte N-1 and an output of a previous byte N-4.

5. The method of claim 1, wherein the bit-wise XORing of the second churned output with a data input and a data output includes XORing with an input of a previous byte N-2 and an output of a previous byte N-5.

6. The method of claim 1, wherein the bit-wise XORing of the third churned output with a data input and a data output includes XORing with an input of a previous byte N-3 and an output of a previous byte N-6.

7. The method of claim 1, wherein the performing a first churning operation to obtain a first churned output includes using from an original 32-bit key the 24 least significant bits, wherein the performing a second churning operation on the first XOR result to obtain a second churned output includes using from the original 32-bit key shifted by one byte the 24 least significant bits, placing the least significant byte first, followed by the two most significant bytes, wherein the performing a third churning operation on the second XOR result includes using from the original 32-bit key shifted by two bytes the 24 least significant bits, placing the two least significant bytes first followed by the most significant byte, and wherein the performing a fourth churning operation on the third XOR result includes using from the original 32-bit key shifted by three bytes the 24 least significant bits, placing the three least significant bytes first.

8. The method of claim 1, further comprising the step of:
(c) at the second network entity, performing a quadruple de-churning operation on encrypted byte N to obtain back original byte N.

9. The method of claim 1, wherein the communication network is a passive optical network, wherein the first network entity is an optical line terminal, and wherein the second network entity is an optical network unit.

10. The method of claim 1, wherein the communication network is a passive optical network, wherein the first network entity is an optical network unit, and wherein the second network entity is an optical line terminal.

11. An apparatus for enhancing the confidentiality of data transmitted between two, first and second communication network entities, comprising:
(a) a first churning engine for performing a first churning operation on a data byte N and for outputting a first churned output;
(b) a first XOR element for bit-wise XORing the first churned output with two values to obtain a first XOR result which is bit-swapped;
(c) a second churning engine for performing a second churning operation on the first bit-swapped XOR result to obtain a second churned output;
(d) a second XOR element for bit-wise XORing the second churned output with two values to obtain a second XOR result which is bit-swapped;
(e) a third churning engine for performing a third churning operation on the second bit-swapped XOR result to obtain a third churned output;
(f) a third XOR element for bit-wise XORing the third churned output with two values to obtain a third XOR result which is bit-swapped; and
(g) a fourth churning engine for performing a fourth churning operation on the third bit-swapped XOR result to obtain an encrypted data byte N which is transmitted from the first network entity to the second network entity;
wherein the apparatus is included in each of the first and second network entities.

12. The apparatus of claim 11, wherein the communication network is a passive optical network, wherein the first network entity is an optical line terminal, and wherein the second network entity is an optical network unit.

13. The apparatus of claim 11, wherein the communication network is a passive optical network, wherein the first network entity is an optical network unit, and wherein the second network entity is an optical line terminal.

14. The apparatus of claim 11, wherein each key in each churning engine is a different key.

15. The apparatus of claim 14, wherein each different key of the second, third, and fourth churning engines is a variation of the key of the first churning engine, without need to extend the key length for providing more information.

16. The apparatus of claim 14, wherein the key used by the first churning engine are bits {[X1:X8], [P1-P16]} from an original 32-bit key {[X1-X8], [P1-P24]}, wherein the key used by the second churning engine is the original 32-bit key shifted by one byte {[P17:P24], [X1:X8], [P1-P8]}, wherein the key used by the third churning engine is the original 32-bit key shifted by two bytes {[P9:P24], [X1:X8]}, and wherein the key used by fourth churning engine is the original 32-bit key shifted by three bytes {[P1:P24]}.
